(19) United States
(12) Patent Application Publication
(10) Pub. No.: US 2007/0293384 A1
(43) Pub. Date: Dec. 20, 2007

(54) Slider assembly having a position changing module

(75) Inventor: Tapio Karkkola, Turku (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/607,807

(22) Filed: Dec. 1, 2006

Related U.S. Application Data
(63) Continuation-in-part of application No. 11/453,754, filed on Jun. 14, 2006.

(51) Int. Cl. B31B 1/88

(52) U.S. Cl. 493/325

(57) ABSTRACT

A sliding assembly has a slider and at least one rail movably engaged with the slider for movement. The rail is coupled to a module operable in a number of module positions. A lever arm is connected between a pin on the slider and the module to change the module positions, such that when the module positions are caused to change, the slider is also caused to move relative to the rail. In a portable device, such as a mobile phone having a first device part and a second device part, the first device part can be fixedly mounted to the slider and the second device part can be fixedly mounted to the rail in order to achieve a sliding motion between the first and second device parts so as to allow the mobile phone to operate between closed and open positions.

This is a Continuation-In-Part Application of and claiming priority to a pending U.S. patent application Ser. No. 11/453,754, filed Jun. 14, 2006, assigned to the assignee of the present invention.

### FIELD OF THE INVENTION

The present invention relates generally to a slider assembly for use in a hand-held device, such as a mobile phone and, more particularly, to a slider assembly having a nose-to-nose modular system.

### BACKGROUND OF THE INVENTION

A small portable device, such as a mobile phone, a communicator device and a personal digital assistant, requires a mechanical linkage between two device parts, such as a cover and a device body, so that one device part can be moved to different positions relative to the other device part. It is desirable that the mechanical linkage is small but reliable. Furthermore, when one device part is moved between positions relative to the other device part, the mechanical linkage is stable at least at one of the positions. Furthermore, the required distance between the relative positions is quite large. In a slide mechanism for use in a small device, the required torsion response (negative or position moment) is often relatively high.

It is thus desirable and advantageous to provide a mechanical device that meets the above-mentioned requirements.

### SUMMARY OF THE INVENTION

In a device having two device parts with one device part arranged to slide against the other, the present invention uses a module, such as a modular spring system, to control the sliding operation. The modular spring system has a module body to accommodate a cam shaft holder on one end and a blocking surface on the other end, along a body axis. The cam shaft holder has a well to accommodate a cam shaft, allowing the cam shaft to rotate therein about a rotational axis. The rotational axis is substantially perpendicular the body axis of the module body. The well has an open section and the cam shaft has a cam tip located near the open section so as to allow a slider with a protruding portion to press against the cam tip through the open section of the well in order to provide a nose interface. A spring is inserted between the blocking surface and the slider to provide stability of a nose interface position. Depending on the shape of the protruding portion of the slider and the shape of the cam tip, the modular spring system can have one, two or more stable nose interface positions. When the cam shaft is rotated so as to move the cam tip from one stable position to another stable position, the slider is caused to temporarily move backward. The cam shaft also has a locking member inserted into a recess or an opening on the cam shaft holder. The locking member prevents the cam shaft from moving out of the well along the rotational axis while allowing the cam shaft to rotate between nose interface positions.

To facilitate the sliding motion, a slider having at least one track is fixedly mounted to one device part and movably engaged with a rail. The other device part is coupled to the rail and the modular spring system. A lever arm is movably connected between a coupling mechanism on the slider and the modular spring system for rotating the cam shaft in order to change the nose interface positions, such that when a nose interface position is caused to change, the slider is also caused to move relative to the other device part as the rail slides on the track.

Thus, the first aspect of the present invention is to a slider assembly. The slider assembly comprises:

a slider having a coupling mechanism;

a rail movably coupled to the slider for movement;

a module mechanically coupled to the rail, the module operable in a plurality of module positions; and

an arm connected between the module and the coupling mechanism for causing the module to change the module positions, such that when the module is caused to change the module positions, the slider is caused to move along a direction relative to the rail. Advantageously, the slider further includes a further track substantially parallel to the track, and said slider assembly further comprises a further rail movably coupled to the further track for movement along the direction. The coupling mechanism can be a pin and one end of the arm has a slot for movably engaging with the pin for moving the slider. The other end of the arm is pivotably coupled to the module to change the module positions.

The slider assembly further comprises a frame having a first frame side and a second frame side, wherein the first frame side is engaged with the rail and the second frame side is engaged with the further rail.

The second aspect of the present invention is a portable device, such as a mobile phone. The portable device has a device part fixedly coupled to the slider for movement relative to the frame. As such, the portable device can be operated between a closed position and an open position.

The third aspect of the present invention is a method for achieving a sliding movement in a portable device having a first device part and a second device part. The method comprises:

mounting the first device part to a slider, the slider comprising a coupling mechanism;

movably engaging a rail to the slider for movement;

fixedly mounting the second device part to the rail;

mounting a module operable in a plurality of module positions to the second device part; and

connecting an arm between the coupling mechanism and the module for causing the module to change the module positions, such that when the module is caused to change the module positions, the slider is caused to move relative to the rail in a moving direction, wherein the module comprises:

a cam shaft; and

a cam shaft holder for retaining the cam shaft while allowing the cam shaft to rotate, wherein the cam shaft is mechanically coupled to the arm so as to allow the arm to rotate the cam shaft for changing the module positions. Advantageously, the slider further includes a further track substantially parallel to the track and the method further comprises movably coupling a further rail to the further track for movement along the moving direction.

The fourth aspect of the present invention is a rail system for use in a slider assembly comprising a slider, the slider having a first track, a separate second track substantially parallel to the first track, and a coupling mechanism. The rail system comprises a first rail configured for movably mounting to the first track; and a second rail configured for movably mounting to the second track. The slider assembly further comprises a module operable in a plurality of module positions mechanically coupled to the first rail; and an arm connecting between with the module and the coupling mechanism for causing the module to change the module positions, such that when the module is caused to change the module positions, the slider is caused to move relative at least to the rail. Advantageously, the second rail is longer than the first rail.

The present invention will become apparent upon reading the description taken in conjunction with FIGS. 1 to 23.

### BRIEF DESCRIPTION OF THE DRAWINGS

FIG. 1 is an isometric view of the modular spring system, according to one embodiment of the present invention, wherein the spring is shown separately from the module body.

FIG. 2 is an isometric view of the module body, according to one embodiment the present invention.

FIG. 3 is an isometric view of the cam shaft, according to one embodiment of the present invention.

FIG. 4 is an isometric view of the module slider, according to one embodiment of the present invention.

FIGS. 5a to 5c are top views showing different nose interfaces of the module.

FIGS. 6a and 6b are top views of a shaft and a module slider showing the bi-stable nature of the modular spring system, according to one embodiment of the present invention.

FIGS. 7a and 7b are top views of a shaft and a module slider showing a mono-stable modular spring system, according to a different embodiment of the present invention.

FIGS. 8a to 8c are top views of a shaft and a module slider showing a tri-stable modular spring system, according to yet another embodiment of the present invention.

FIG. 9 is an isometric view of the cam shaft, according to another embodiment of the present invention.

FIGS. 10a and 10b show two embodiments of a lever arm, according to the present invention.

FIG. 11 is an exploded view of a slider-frame assembly, according to one embodiment of the present invention.

FIG. 12a is an isometric view of a slider assembly, according to one embodiment of the present invention.

FIG. 12b is another isometric view of the slider assembly.

FIG. 13 is an isometric view of a first rail, according to the present invention.

FIG. 14 is an isometric view of a second rail, according to the present invention.

FIGS. 15a to 15c show the plan views of the slider assembly at different operational positions.

FIGS. 16a to 16c show the side views of the slider assembly at different operational positions.

FIG. 17 shows a frame assembly.

FIG. 18 shows an isometric view of the slider-frame assembly.

FIG. 19 shows another view of the slider-frame assembly.

FIGS. 20a and 20b are side views showing two different operational positions of the slider-frame assembly.

FIGS. 21a and 21b are schematic representations showing exploded views of a portable device in a closed position and in an open position.

FIG. 22 is an end view of the slider assembly.

FIG. 23 is a flowchart illustrating the method for achieving a sliding movement in a portable device.

### DETAILED DESCRIPTION OF THE INVENTION

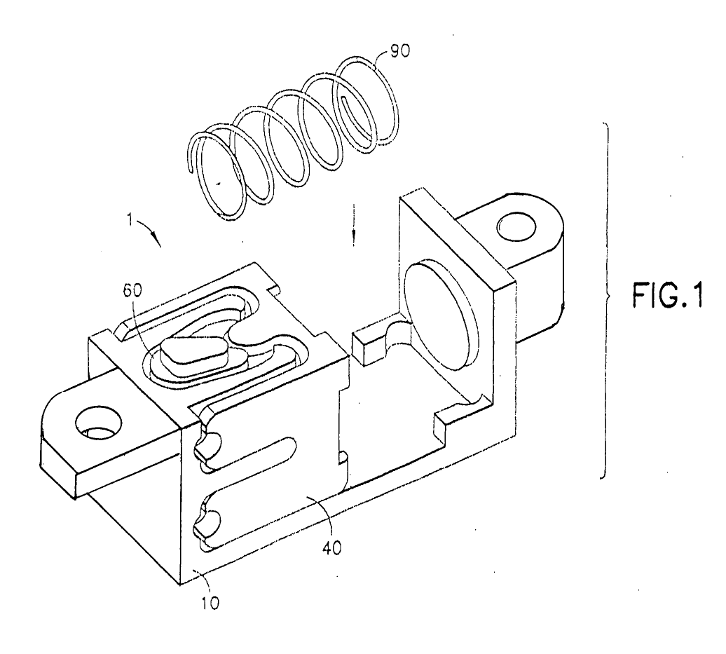

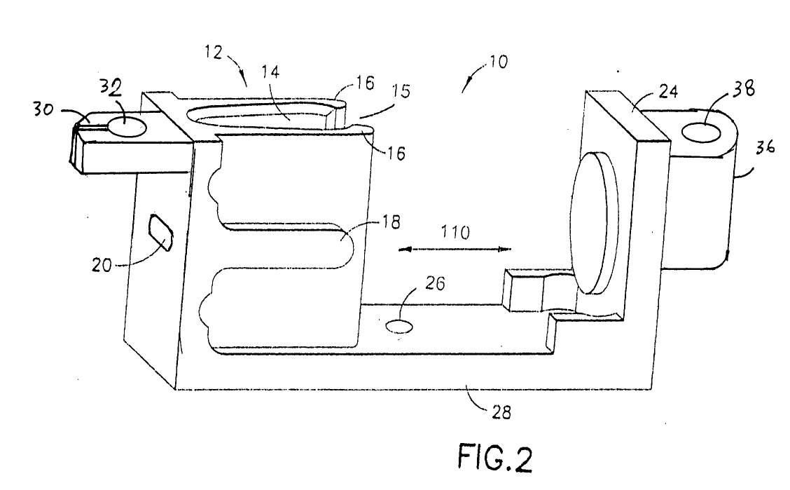

The modular spring system 1, according to the present invention, has a module body 10 to hold a cam shaft 60 and a module slider 40 to provide nose interfaces between the module slider and the cam shaft, as shown in FIG. 1. A spring 90 is used to urge the module slider to press against the cam shaft along the module body axis 110, as shown in FIG. 2.

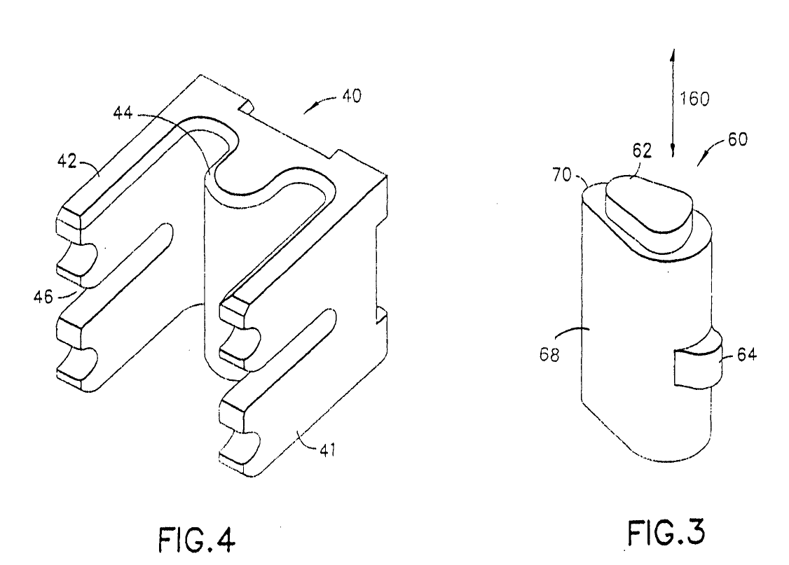

As shown in FIG. 2, the module body 10 has a module base 28, a cam shaft holder 12 located on one end and an end block 24 on the other end. The cam shaft holder 12 has two arms 16 to define a shaft well 14. Each of the arms 16 has an alignment guide 18 to guide the module slider 40 into position in the assembling process. The arms 16 define an opening section 15 of the cam shaft holder 12. The cam shaft holder has a retaining aperture 20 to prevent the cam shaft 60 from sliding off the shaft well 14 along the axis 160 (see FIG. 3) after all the components are assembled. The module base 28 has a mounting hole 26. The module body 10 also has a mounting bracket 30 with a mounting slot or aperture 32. Additionally, another mounting bracket 36 with a hole or slot 38 is provided on the end block 24. The mounting aperture 32, the mounting hole 38 and the mounting hole 26 can be used for mounting the modular spring module 1 on a device or structure.

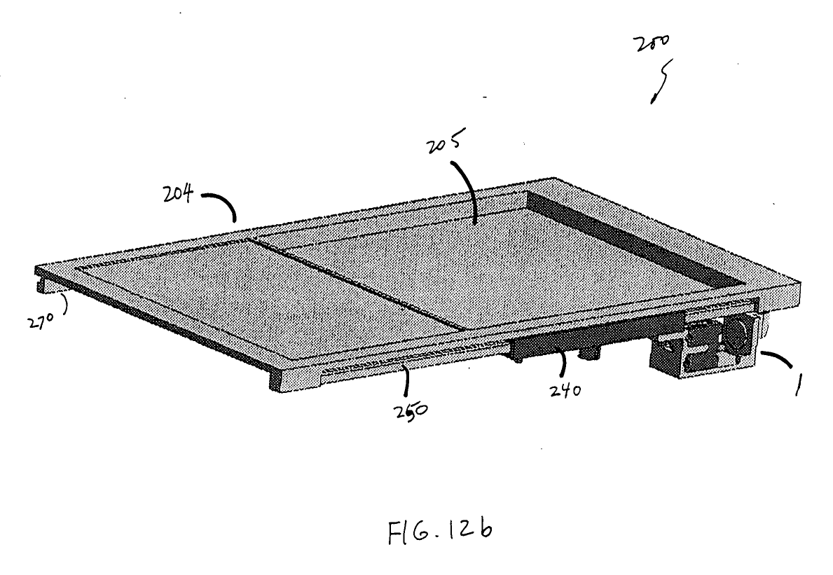

FIG. 3 is an isometric view of the cam shaft 60. As shown, the cam shaft 60 has a shaft 68 rotatable about a rotation axis 160 in the well of the cam shaft holder. The shaft 68 has a locking member 64 protruding from the shaft surface. The locking member 64 is dimensioned to be moved into the retaining aperture 20 of the cam shaft holder (see FIG. 2). The retaining aperture 20 is wider than the locking member 64 so as to allow the shaft to rotate about the rotation axis 160 within a predetermined angular range. The shaft 68 has a cam tip 70 which is used to provide a nose interface with the module slider 40. A joint 62, located on top of the shaft 68, is used to provide a mechanical linkage to an external part. The external part, such as a lever arm 210 having an aperture 214 as shown in FIG. 10a, can be used to change the nose-interface positions of a modular spring module 1 by engaging the aperture 214 with the joint 62 on the cam shaft 60.

FIG. 4 shows an isometric view of the module slider 40. As shown, the module slider 40 has a first side wall 41, a second side wall 42 and a protruding member 44 located between the two side walls 41, 42. Each of the side walls has a guiding slot 46 to be slid into the alignment guides 18 for assembling after the cam shaft 60 is placed into the shaft well 14 with the locking member 64 of the cam shaft 60 being inserted into the retaining aperture 20. After the cam shaft 60, the module slider 40 and the module body 10 are properly assembled, a spring 90 is inserted in the space between the end wall 24 and the module slider 40 (see FIG. 1). The spring 90 provides a force to urge the protruding member 44 to press against the cam tip 70 of the cam shaft 60.

According to one embodiment of the present invention, the cross section of the protruding member 44 has a circular arc to be interacted with the cam tip 70 of the cam shaft 60. As such, the cam tip 70 can be located in a first position between the protruding member 44 and the first side wall 41, or in a second position between the protruding member and the second side wall 42. Because of the shape of the protruding member 44 and the urging force of the spring 90, the cam tip 70 cannot move freely between the first and second positions. Thus, each of the first and second positions is a mechanically stable position or a stable nose interface.

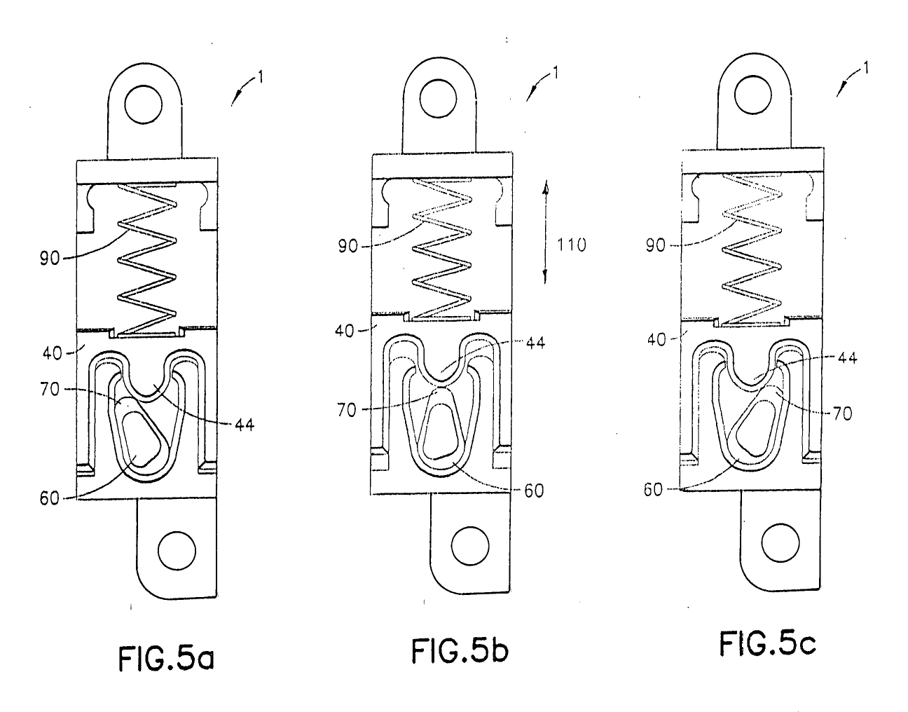

When the joint 62 is engaged with a lever arm, for example, the lever arm can move the cam shaft from one stable nose interface to another against the urging force of the spring 90. As shown in FIG. 5a, the cam shaft is positioned in the first stable position between the protruding member and the first side wall. As shown in FIG. 5b, the cam shaft is in a transitional position, which is unstable. In this position, the module slider 40 is moved toward the end block along the body axis 110. As shown in FIG. 5c, the cam shaft is positioned in the second stable position between the protruding member and the second side wall.

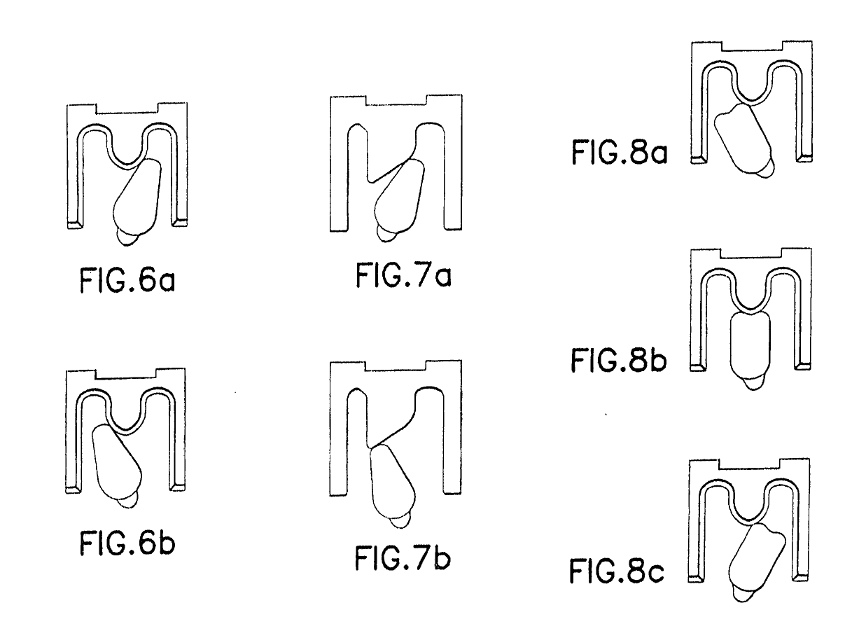

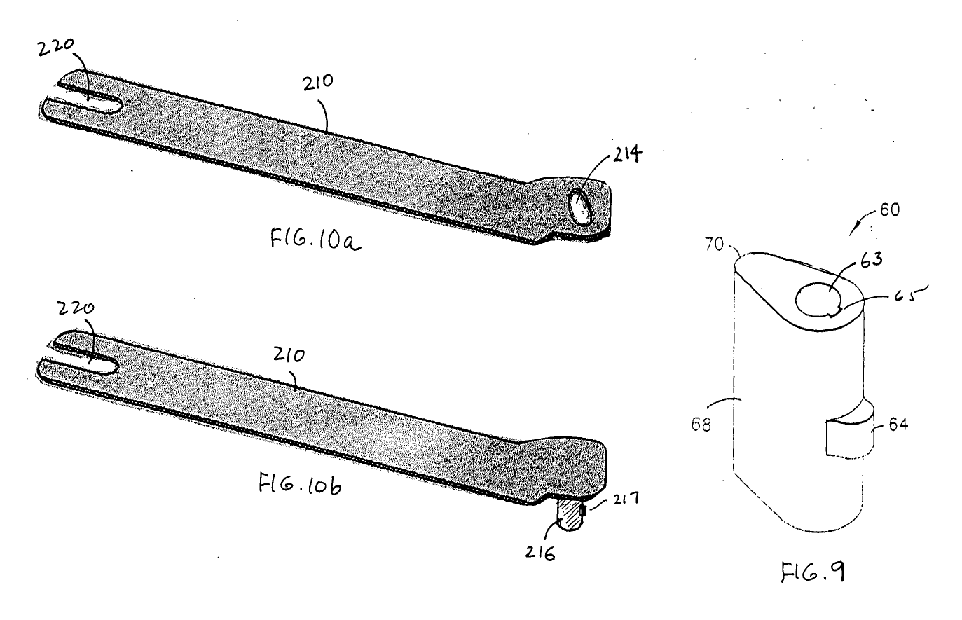

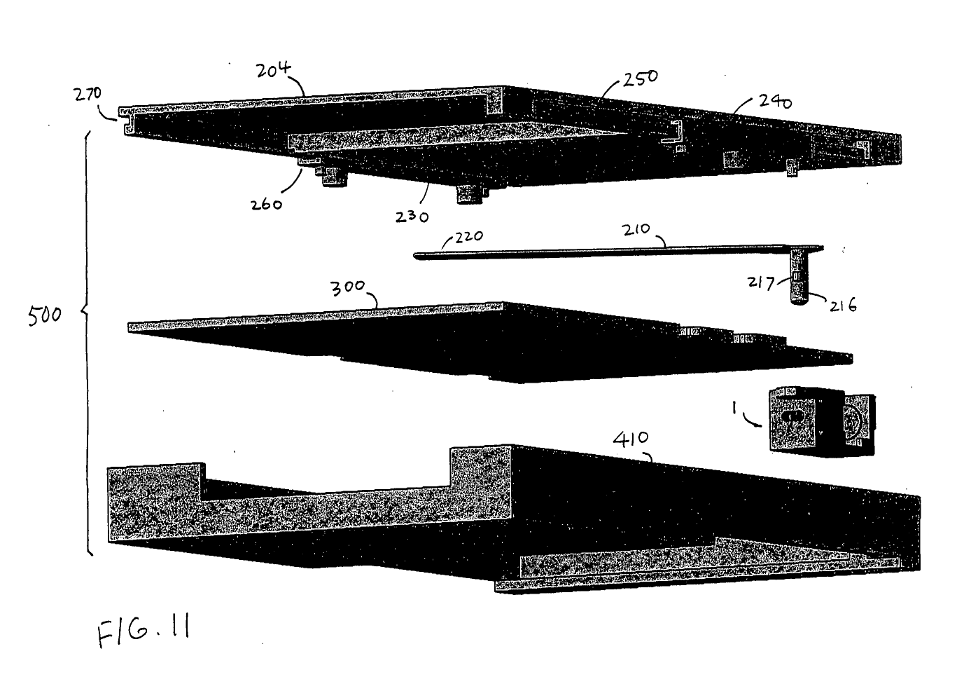

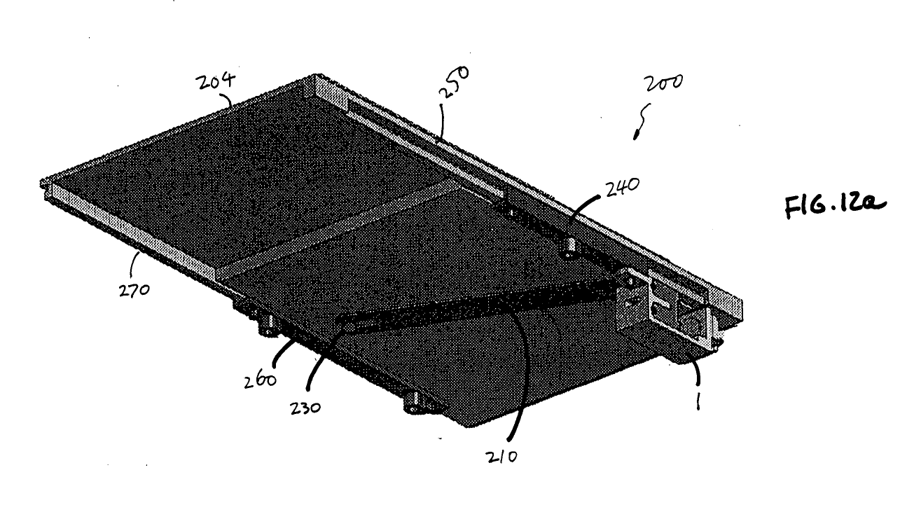

Depending on the shape of the protruding member of the slider and the shape of the cam tip of the cam shaft, the modular spring system can be bi-stable in that it has two stable nose-interface positions. FIGS. 6a and 6b show two such stable positions. The modular spring system can be mono-stable in that it has only one stable nose-interface position. FIG. 7a shows a stable position whereas FIG. 7b shows an unstable position. The modular spring system can have three or more stable positions. As shown in FIG. 8a, the cam tip and the protruding member form a first stable nose interface. As shown in FIG. 8b, the cam tip and the protruding member form a second stable nose interface. As shown in FIG. 8c, the cam tip and the protruding member form a third stable nose interface.

FIG. 9 shows another embodiment of the cam shaft 60. Instead of having a joint 62 on top of the shaft 68 for providing a mechanical linkage to an external part, a shaft hole 63 having a key slot 65 can be use for the linkage. The external part, such as a lever arm 210 having a pin 216 with a protruding key 217 as shown in FIG. 10b, can be used to change the nose-interface positions of a modular spring module 1 by engaging the pin 216 with the hole 63 on the cam shaft 60.

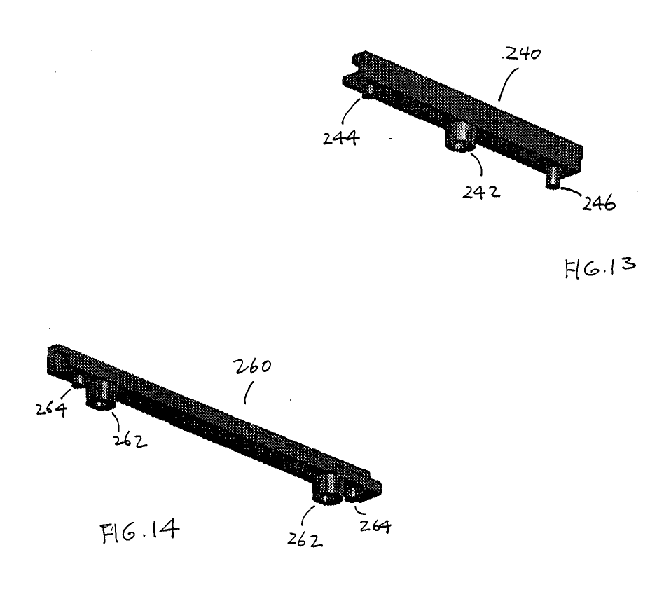

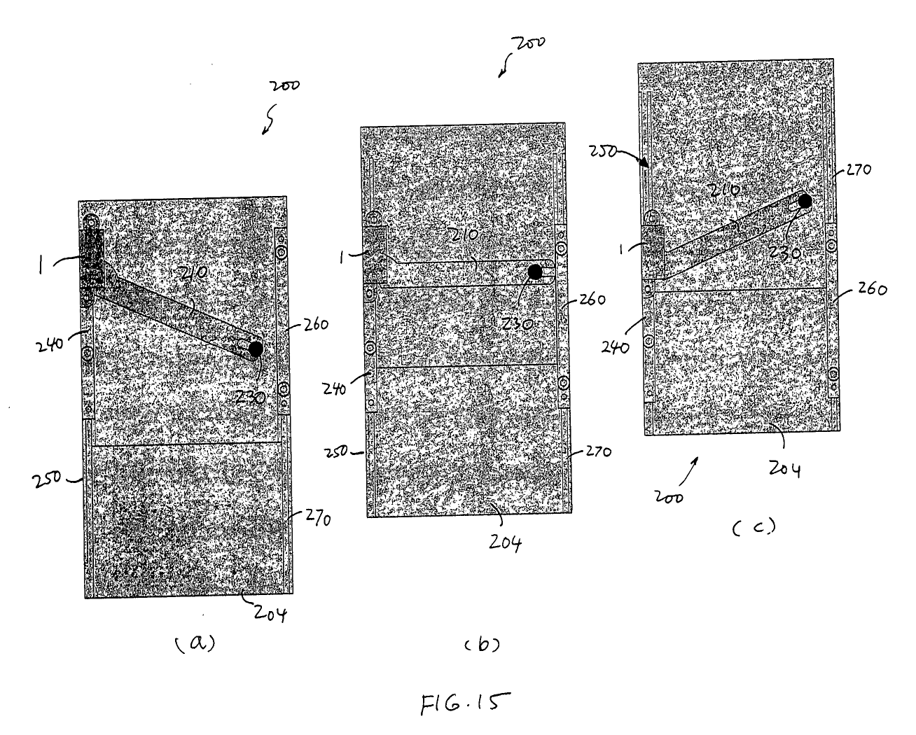

FIG. 11 shows an exploded view of the slider-frame assembly of the present invention. The slider-frame assembly 500 uses a modular spring module 1 and a lever arm 210 to move a slider 204 relative to a frame 410. As shown in FIG. 11, the slider 204 has two parallel tracks 250, 270 to be engaged with two rails. The first rail 240 is movably engaged with the track 250 and the second rail 260 is movably engaged with the track 270. The first and second rails 240, 260 are fixedly mounted to the frame 410 so as to allow the frame 410 to move relative to the slider 204. The modular spring module 1 is mounted on the track 250 (see FIGS. 12a and 12b). The pin 216 on one end of the lever arm is rotatably coupled to the modular spring module 1 to change the nose interface positions. The slot 220 on the other end of the lever arm is movably engaged with a pin 230 on the slider 204 for moving the slider 204 along the first and second rails 240, 260 relative to the modular spring module 1, as shown in FIGS. 12a and 12b.

The slider-frame assembly as shown in FIG. 11 also has a circuit board, such as a printed-wire board (PWB) 300 configured to be placed inside the frame 410 as shown in FIG. 17.

FIG. 12a is an isometric view of a slider assembly 200, showing the engagement of the first rail 240 to the track 250 and the modular spring module 1, and the engagement of the second rail 260 to the track 270. FIG. 12a also shows the engagement of the lever arm 210 to the slider 230 and the modular spring module 1. It should be noted that the lever arm 210 can be in contact with part of the slider 204 to cause the slider to move relative to the modular spring module 1. Because the modular spring module 1 can be placed on a corner of the slider assembly 200, the size of modular spring module is generally not a factor in determining the thickness of a device that uses the slider assembly for sliding. In order to reduce the thickness of such a device, the contacting part of the slider 204 and the lever arm 210 can be made as thin as possible so long as they are strong enough to support the sliding movement.

FIG. 12b shows another view of the slider assembly 200. As shown, the slider 204 has an indent portion or cavity 205 for accommodating some components of the device that uses the slider assembly 200 for sliding. For example, if the device that uses the slider assembly 200 is a mobile phone, the cavity 205 can be used for placing a display panel.

FIG. 13 shows an isometric view of the first rail 240. As shown, the first rail 240 has a screw mount 242 so that a screw or a similar fastener can be used to fixedly engage the frame 410 to the first rail. The first rail 240 has a registration pin 244 to position the frame 410 when the frame is affixed to the first rail 240. The first rail 240 also has an engaging pin 246 for mechanically coupling the first rail 240 to the mounting bracket 30 of the modular spring module 1 and for positioning the frame 410 when the frame is affixed to the first rail 240.

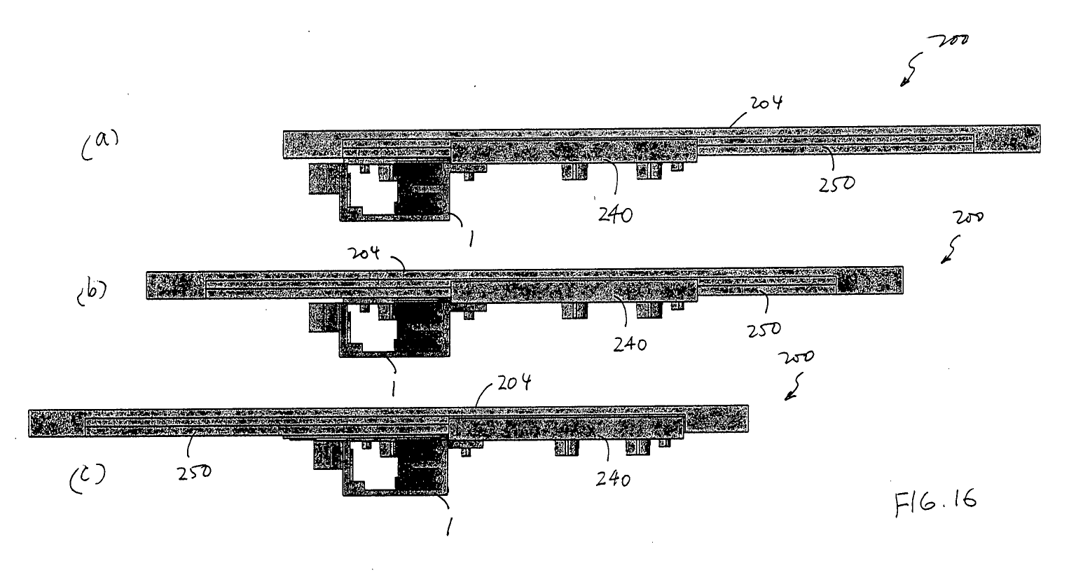

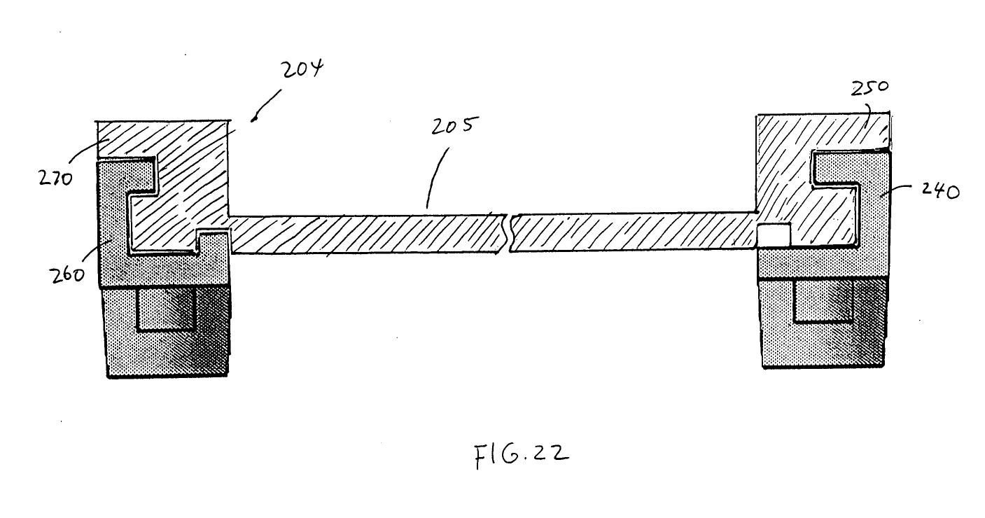

FIG. 14 shows an isometric view of the second rail 260. As shown, the second rail 260 has two screw mounts 262 and two registration pins 264 to mechanically link to the frame 410. It should be noted that because the modular spring module 1 is linked to the first rail 240, the second rail 260 can be longer than the first rail 240. Also, the cross section of the second rail 260 can also be different from the cross section of the first rail 240 (see FIG. 22).

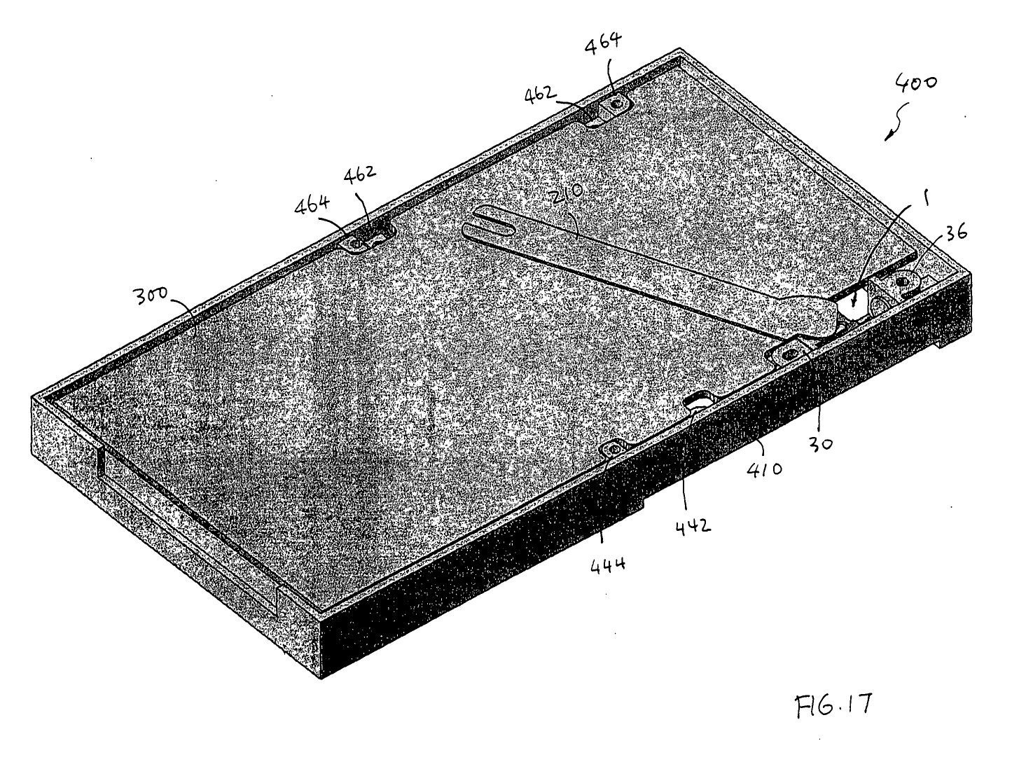

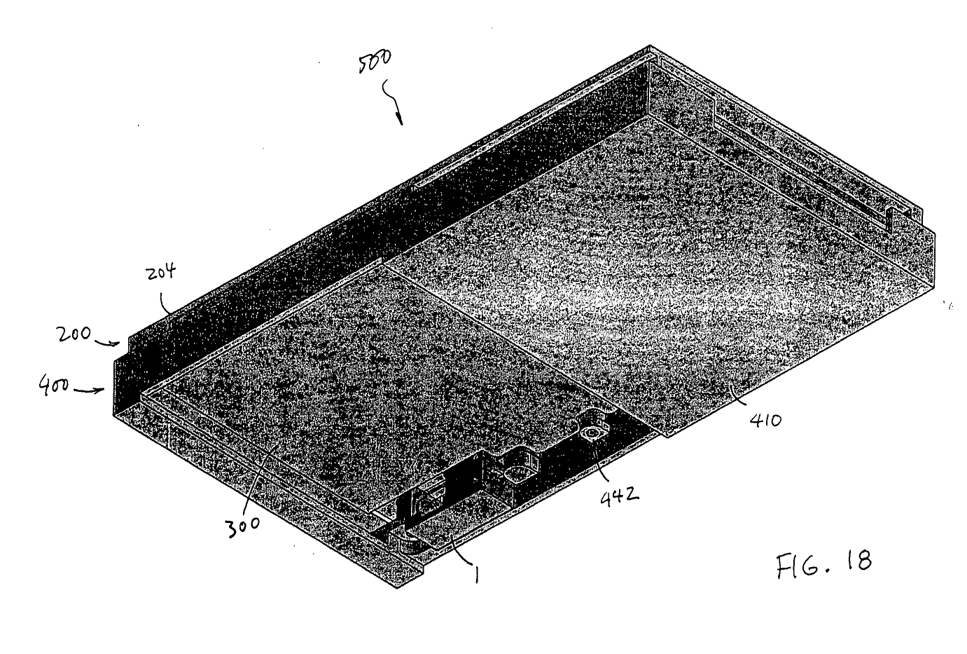

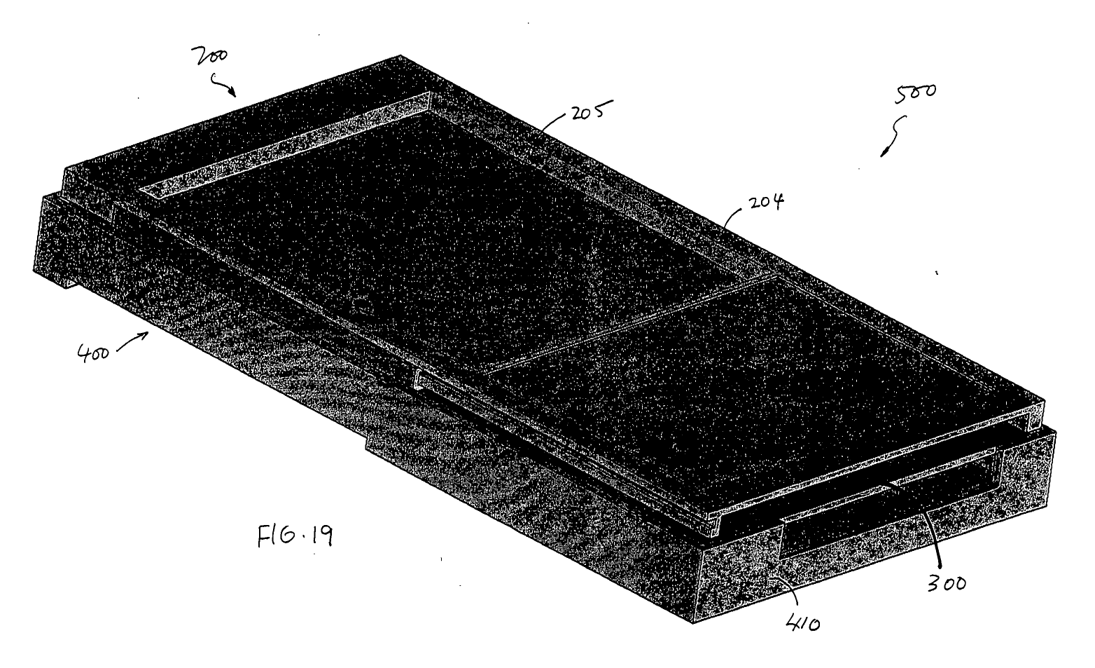

FIGS. 15a to 15c are plan views showing the sliding operation of the slider assembly. FIGS. 16a to 16c are side views showing the sliding operation of the slider assembly. For clarity, the spring 90 (see FIG. 1) in the modular spring module 1 is not shown.

FIG. 17 shows an isometric view of the frame assembly 400. As shown, the frame assembly includes a frame 410, a circuit board or PWB 300 placed in the frame 410 and a lever arm 210 adjacent to the PWB 300. One side of the frame 410 has two screw mounts 462 to be coupled to the screw mounts 262 on the second rails and two registration holes 464 to be coupled to the registration pins 264 (FIG. 14) through the cutout portions of the PWB 300. The other side of the frame 410 has a registration hole 444 to be coupled with the registration pin 244 on the first rail, a screw mount 442 to be coupled to the screw mount 242 (FIG. 13) through similar cutout portions of the PWB 300. The first rail 240 is also aligned to the frame 410 by the pin 246. One corner of the PWB 300 is also cut out to allow the coupling between the first rail and the modular spring module, and between the arm 210 and the modular spring module 1.

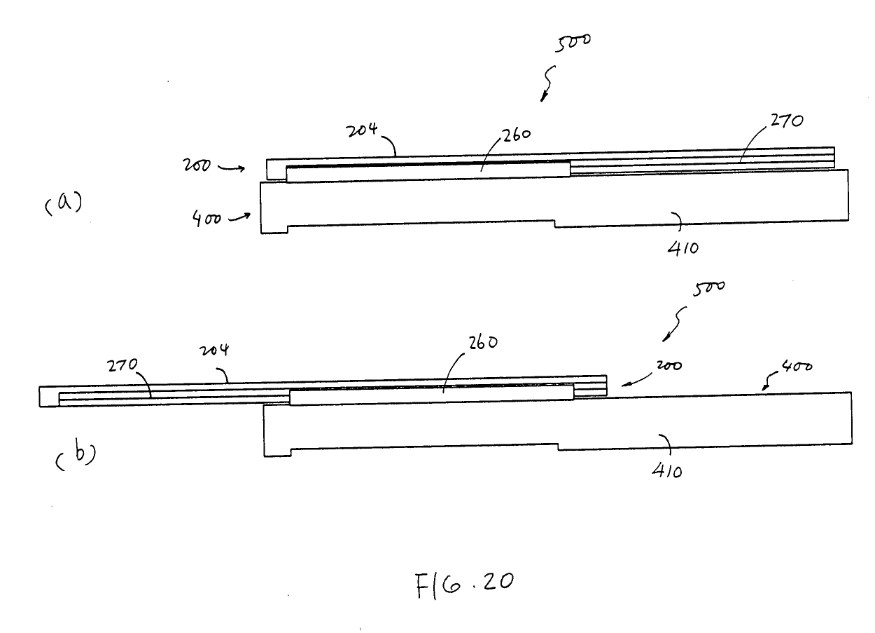

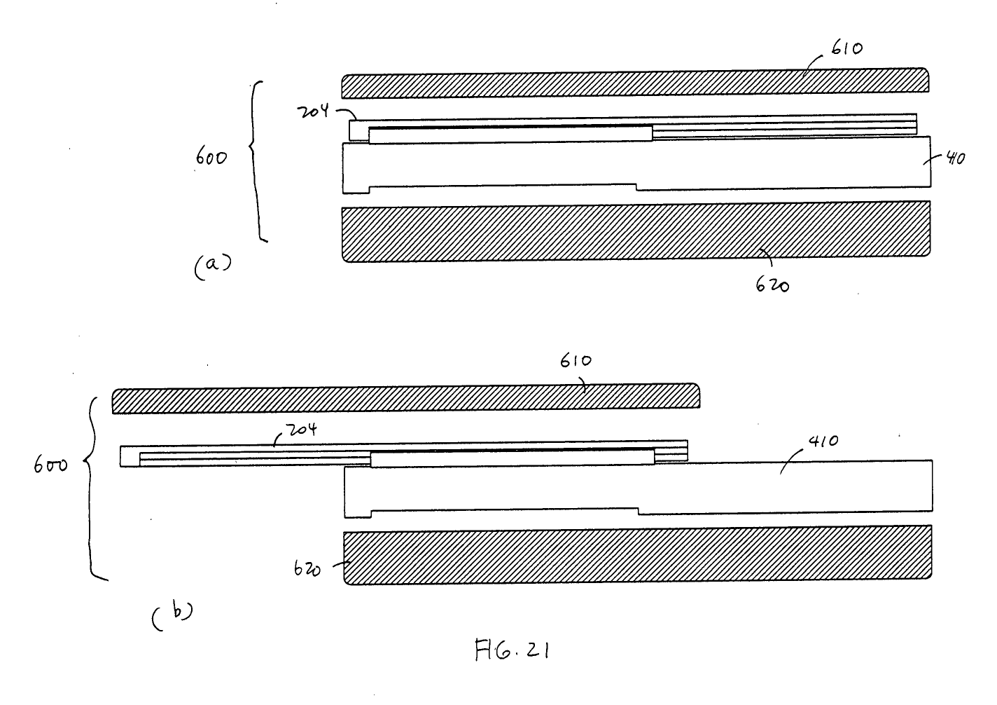

FIGS. 18 and 19 show different views of the slider-frame assembly 500 of the present invention. As shown in FIGS. 18 and 19, the slider-frame assembly 500 comprises a slider assembly 200 and a frame assembly linked by the tracks 250, 270 and rails 240, 260 for sliding motion (FIGS. 12a-17). FIGS. 20a and 20b are side-views of the slider-frame assembly 500 in a closed position and an open position. When the slider-frame assembly 500 is in the open position, part of the frame assembly 410 and part of the slider 204 are exposed.

The slider-frame assembly 500 can be used in a portable device, such a mobile phone having a slide-feature. Such a portable device is illustrated in exploded views in FIGS. 21a and 21b. As shown in FIGS. 21a and 21b, the device 600 has a first device part 610 and a second device part 620. The first device part 610 is dimensioned as a housing for the slider 204 and the second device part 620 is dimensioned as a housing for the frame 410. In a mobile phone with a slide-feature, the first device part 610 can be an upper cover or A-cover, and the second device part 620 can be assembled to the frame 410 which is also known as a B-cover. FIG. 21a shows the mobile phone in a closed position. FIG. 21b sows the mobile phone in an open position, exposing some inner parts of the mobile phones. The exposed parts may include a LCD display, a keyboard or other components. If the modular spring module is designed to be bi-stable as illustrated in FIGS. 6a and 6b, then the mobile phone is operable in an open position and a closed position. If the modular spring module is designed to be mono-stable as illustrated in FIGS. 7a and 7b, the upper cover (A-cover) would pop out when a release button is pressed in order to release the slider. The single-stable construction is also referred to as a one-way stiletto. If the modular spring module is designed to be tri-stable as illustrated in FIGS. 8a to 8c, the mobile phone will also have a middle position, in addition to the open and closed positions.

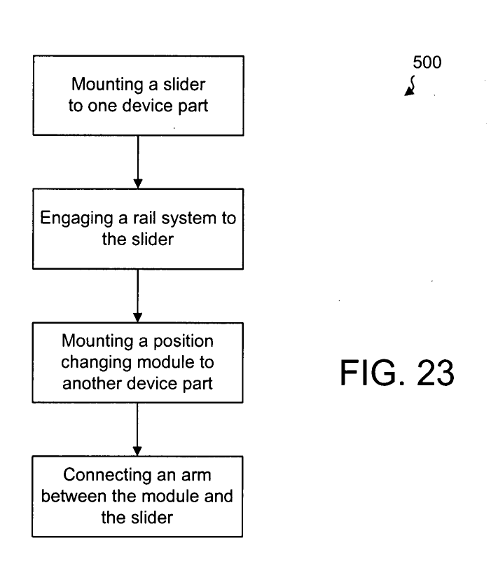

As shown in FIGS. 12a, 13 and 14, the first and second rails are not symmetrical. They are of different lengths. Moreover, the cross-section of the first rail 240 is different from the cross-section of the second rail 260, as shown in FIG. 22. Unlike a conventional slider-feature where an actuator is located between a slider and a base, the slider-feature according to the present invention can be operated without a base as the actuator is replaced by a lever arm. The lever arm is mechanically linked and supported by the modular spring module which is linked to a rail engaged with a track on the slider. By replacing the actuator with a lever arm, the thickness of slider assembly can be significantly reduced. In the present invention, the second device part 620 will become unnecessary, since frame 410 is functioning as a base of the slide module. Therefore, the slide module can be called baseless and the frame 410 can be called B-cover in this context. The open area or cavity in the lower side of the frame 410 (FIGS. 20a and 20b) can be used as a battery compartment to be closed with a battery cover, for example. FIG. 23 summarizes the method for achieving a sliding movement in a portable device having two device parts. As shown in the flowchart 500, the method comprises mounting one device part to a slider with a coupling mechanism; movably engaging a rail to the slider for movement; fixedly mounting another device part to the rail; mounting a positioning changing module to the other device part, the modular spring module operable in a plurality of module positions; and connecting an arm between the coupling mechanism and module for causing the module to change the module positions, such that when the module is caused to change the module positions, the slider is caused to move relative to the rail in a moving direction.

In sum, the present invention provides a module operable in a plurality of module positions. The module, together with a lever arm, can be used in a slider assembly to achieve different slider positions. The slider assembly can be one, two or more stable slider positions depending on the design of the module. This position changing module can be the modular spring system 1 as illustrated in FIG. 1, but it can be a modular system of a different design that is operable in a number of module positions.

Thus, although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. A slider assembly comprising:
a slider having a coupling mechanism;
a rail moveably coupled to the slider for movement;
a module operable in a plurality of module positions mechanically coupled to the rail; and
an arm connected between the coupling mechanism and the module for causing the module to change the module positions, such that when the module is caused to change the module positions, the slider is caused to move along a direction relative to the rail.

2. The slider assembly of claim 1, wherein the slider further includes a further track substantially parallel to the track, said slider assembly further comprising:
a further rail movably coupled to the further track for movement along the direction.

3. The slider assembly of claim 2, wherein the coupling mechanism comprises a pin, and wherein the arm has a first arm end pivotably coupled to the module to change the module positions and a second arm end having a slot movably engaged with the pin for moving the slider.

4. The slider assembly of claim 3, wherein the module comprises:
a cam shaft; and
a cam shaft holder for retaining the cam shaft while allowing the cam shaft to rotate, wherein the cam shaft is mechanically coupled to the first arm end so as to allow the arm to rotate the cam shaft for changing the module positions.

5. The slider assembly of claim 4, wherein the cam shaft has a camp tip, the module further comprising:
a module body having:
a first end and an opposing second end defining a body axis, the second end having an end block, wherein the cam shaft holder is located on the first end, the cam shaft holder having two arms defining a shaft well for placing the cam shaft therein, the shaft well having an open section facing the end block, and wherein the cam tip is positioned adjacent to the open section and the cam shaft is rotatable about a rotational axis substantially perpendicular to the body axis, allowing the cam tip to move between the two arms of the shaft well;
a retainer disposed between the cam shaft holder and the end block, the retainer having a protruding member facing the shaft well, wherein the retainer is slidable in a moving direction substantially parallel to the body axis; and
a spring located between the retainer and the end block for providing an urging force to urge the protruding member to press against the cam tip through the open section of the shaft well while allowing the cam shaft to rotate about the rotational axis.

6. The slider assembly of claim 5, wherein the module positions include a first module position and a second module position, and wherein the retainer has a first side wall and a second side wall located on opposite sides of the protruding member, and the protruding member and the cam shaft are dimensioned to allow the cam tip to be positioned in a first position between the first side wall and the protruding member when the module is operated in the first module position, or in a second position between the second side wall and the protruding member when the module is operated in the second module position.

7. The slider assembly of claim 6, wherein when the cam tip is moved between the first position and the second position, the retainer is caused to move in the moving direction toward the end block against the urging force.

8. The slider assembly of claim 5, wherein the retainer has a first side, an opposing second side and at least a side wall on the first side, and wherein the protruding member and the cam shaft are dimensioned to allow the cam tip to be positioned in a first position between the side wall and the protruding member.

9. The slider assembly of claim 8, wherein the cam shaft can be caused to rotate such that the cam tip is moved toward the second side to a second position between the side wall and the protruding member while the retainer is caused to move in the moving direction toward the end block against the urging force.

10. The slider assembly of claim 5, wherein the cam shaft has a joint and the first arm end of the arm has an aperture dimensioned to couple with the joint for rotating the cam shaft about the rotational axis.

11. The slider assembly of claim 5, wherein the cam shaft has an opening and the first arm end of the arm has a protruding member dimensioned to engage with the opening for rotating the cam shaft.

12. The slider assembly of claim 2, further comprising:
a frame having a first frame side and a second frame side, wherein the first frame side is engaged with the rail and the second frame side is engaged with the further rail.

13. A portable device having a slider assembly of claim 12, wherein the portable device comprises a device body fixedly coupled to the slider for movement relative to the frame.

14. The portable device of claim 13 comprising a mobile phone.

15. A method for achieving a sliding movement in a portable device having a first device part and a second device part, said method comprising:
mounting the first device part to a slider, the slider comprising a coupling mechanism;
movably engaging a rail to the slider for movement;
fixedly mounting the second device part to the rail;
mounting a module to the second device part, the modular spring module operable in a plurality of module positions; and
connecting an arm between the coupling mechanism and module for causing the module to change the module positions, such that when the module is caused to change the module positions, the slider is caused to move relative to the rail in a moving direction.

16. The method of claim 15, wherein the module comprises:
a cam shaft; and
a cam shaft holder for retaining the cam shaft while allowing the cam shaft to rotate, wherein the cam shaft is mechanically coupled to the arm so as to allow the arm to rotate the cam shaft for changing the module positions.

17. The slider assembly of claim 16, wherein the slider further includes a further track substantially parallel to the track, said method further comprising:
movably coupling a further rail to the further track for movement along the moving direction.

18. A rail system for use in a slider assembly comprising a slider, the slider having a first track, a separate second track substantially parallel to the first track, and a coupling mechanism, said rail system comprising:
a first rail configured for movably mounting to the first track; and
a second rail configured for movably mounting to the second track, wherein the slider assembly further comprises:
a modular operable in a plurality of module positions mechanically coupled to the first rail; and
an arm connecting between with the coupling mechanism and the module for causing the module to change the module positions, such that when the module is caused to change the module positions, the slider is caused to move relative at least to the rail.

19. The rail system of claim 18, wherein the slider assembly further comprises a frame and the first and second rails comprise coupling mechanisms for fixedly mounting to the frame so that when the system is caused to change module positions, the slider is also caused to move relative to the frame.

20. The rail system of claim 18, wherein the first rail has a first length and the second rail has a second length greater than the first length.
